(19) United States
(12) Patent Application Publication
(10) Pub. No.: US 2008/0155663 A1
(43) Pub. Date: Jun. 26, 2008

(54) System and method to implement an access control on a home network

(76) Inventors: Kenneth L. Knowlson, Portland, OR (US); Pronay Dutta, Beaverton, OR (US); Dennis P. O'Connor, Granite Bay, CA (US)

Correspondence Address: INTEL/BLAKELY, 1279 OAKMEAD PARKWAY, SUNNYVALE, CA, 94085-4040, US

(21) Appl. No.: 11/644,463

(22) Filed: Dec. 21, 2006

(51) Int. Cl. G06F 21/00

(52) U.S. Cl. 726/5

(57) ABSTRACT

A client device receives one or more identifiers for one or more access-protected resources from a server. An identifier for an access-protected resource is communicated to a remote user interface (RUI) client. The RUI client requests the access-protected resource from a RUI server and sends an access code to the RUI server. The access-protected resource is received in response to transmitting the access code.

### FIELD

Embodiments of the invention relate to home networks and more particularly to implementing access control on a home network.

### BACKGROUND

Universal Plug and Play (UPnP) refers to a set of protocols promulgated by the UPnP Forum and the Digital Living Network Alliance (DLNA). UPnP is built on an existing set of protocols and formats (e.g., Hypertext Transfer Protocol (HTTP), eXtensible Markup Language (XML), Simple Object Access Protocol (SOAP), the Document Object Model, and IP multicast). (UPnP Device Architecture, version 1.0, Jun. 13, 2000; in addition, see Basic: 1.0, Device Definition Version 1.0 For UPnP Version 1.0, Feb. 12, 2002, and definitions for specific types of UPnP devices). A UPnP device is a device that is substantially compliant with UPnP or a derivative thereof, which are hereinafter referred to simply as UPnP. UPnP is intended to enable devices to connect seamlessly and to simplify the implementation of networks. UPnP enables data communication between any two devices under the command of any control device on the network. UPnP allows devices, particular media devices, to connect seamlessly and simplifies the implementation of smaller networks (e.g., home networks). UPnP technology can run on almost any medium including phone lines, power lines (e.g., PLC), Ethernet, IR (e.g., IrDA), RF (e.g., Wi-Fi, BlueTooth), and FireWire. UPnP does not use device drivers; common protocols are used instead.

For example, UPnP Audio and Video (UPnP AV) technology can be used in a home network to allow a person to listen to music stored on a laptop computer from a separate high-end audio system. In another example, UPnP AV technology can be used in a home network to allow a person to watch home videos stored on a personal computer (PC) from any television anywhere in the home.

UPnP AV is an example of an open-access protocol. As used herein, an open-access protocol is any protocol that has no built-in security or ability to restrict access to content transmitted using the protocol. In other words, an open-access protocol does not support the notion of users or the exchange of private user information such as a password or a personal identification number (PIN).

In general, the example networks described above include a server (e.g., laptop, PC, etc.) that stores content and one or more client devices (e.g., audio system, T.V., etc.) that access the content from the server. The lack of access control in networks using open-access protocols, such as UPnP, can be problematic because there is no control over who accesses content or what content they access from the server. With home networks in particular, open-access protocols are not set up to provide parental control. For example, content generally deemed inappropriate for children (e.g., R-rated movies, music with explicit lyrics, etc.) cannot be restricted (e.g., password protected) using UPnP and other open-access protocols.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram illustrating an embodiment of a system that includes a server and a digital media device.

FIG. 2 is a block/flow diagram further illustrating an embodiment that includes communications between a remote user interface server and client.

FIG. 3 is a block diagram illustrating an embodiment of the invention.

### DETAILED DESCRIPTION

UPnP AV, is a protocol developed by the UPnP Forum and adopted by the Digital Living Network Alliance (DLNA) and supports a service called a Content Directory Service (CDS). The CDS runs on a serving device (e.g., a host PC, server, etc.) that has media to share and provides a network interface to this media so that the media can be accessed by digital media devices and/or UPnP AV clients (e.g., a digital media player (DMP)) on a network. As used herein, a digital media player refers to any device or application capable of playing digital media content (e.g., audio, video, etc.). The CDS exposes Universal Resource Identifiers (URIs) for each exposed item in the serving device's database. Typically, these URIs point to the actual media item (or a reference to a virtual media item if technologies such as transcoding are supported). Thus, using the exposed URIs, DMPs and other UPnP AV clients on the network can browse, access and play the media stored on the serving device.

In one embodiment, a digital media device includes a DMP application to play media content and a remote user interface (RUI) application (e.g., UPnP RUI). As used herein, a RUI application running on a client (e.g., digital media device) is referred to as a “RUI client,” while a RUI application running on a serving device is referred to as a “RUI server.” In general, a RUI application enables application remoting, which allows an application running on a first device to invoke a subroutine on a second device, with execution results of the subroutine oftentimes being communicated back to the application running on the first device. In other words, a RUI application allows an application and its user interface (UI) to be executed on different platforms.

In particular, application display images can be remoted from a server to a client. As used herein, remoting refers to any process that allows a user on a remote client device to interact directly with an application running on a separate serving device. For example, a data processing application running on a server might include a display image for a user interface that allows a user to input data (e.g., via an input/output (I/O) device connected to the server such as a keyboard, mouse, touchscreen, etc.) which is subsequently processed by the application. By remoting the display image to a remote location (e.g., a client device) using a RUI server, a user can input data into the client device rather than be required to input data directly into the server. A RUI client can then send the input data back to the RUI server to be processed by data processing application.

In one embodiment, a RUI application is used to provide access control over media content stored on a UPnP server. While descriptions and explanations used herein refer to the UPnP family of protocols and related devices, a RUI application can be used to provide access control over any content communicated over a network (e.g., Internet Protocol (IP), Ethernet, Institute of Electrical and Electronics Engineers (IEEE) 802.11, etc.) connection using any network protocol. For example, access control could be implemented on the Internet to transfer files using File Transfer Protocol (FTP) and Hyper Text Markup Language (HTML). Other protocols (e.g., extensible Server Pages (XSP)) can be used in other embodiments.

URIs associated with media items designated for access control are modified to point to an access control RUI application instead of pointing to the actual media item. A URI modified to point to an access control RUI application is referred to herein as a “RUI URI.” A UPnP digital media player (DMP) running on a digital media device browses for media content exposed by the Content Directory Service (CDS). The browse returns a list of one or more URIs, some of which are standard URIs and others are RUI URIs.

When the DMP encounters a standard URI, the media item(s) associated with the URI is retrieved (e.g., streamed) based at least in part on the pointer to the media item. The media item is played in conjunction with a local DMP user interface that displays metadata about the media item currently playing (e.g., artist, title, etc.). However, when the DMP encounters a RUI URI, the DMP switches context to handle the RUI URI. This is because a RUI URI does not point to a media item; a RUI URI points an access control RUI application. Thus, the local DMP UI saves its context and switches to an RUI client mode and the RUI URI is communicated to the RUI client.

The RUI client establishes an RUI connection with an RUI server running on the serving device and requests the media item specified in the RUI URI. In response, the RUI server renders an access control UI that is remoted to the digital media device for display on the digital media device. In one embodiment, the access control UI requires a user to enter a personal identification number (PIN). In other embodiments, the access control UI may require a user to answer a security question or enter some other form of access code and/or password. The PIN (or access code, password, etc.) entered by the user is communicated back to the RUI server for verification (e.g., matching the user-entered PIN to a PIN stored in the RUI server). Once the PIN has been verified, the RUI server retrieves a standard URI for the requested media item from the CDS and sends the URI to the RUI client. The RUI client communicates the URI to the DMP and the DMP restores its context to play the media item based on the URI. In the embodiment described above, the standard URI enables the DMP to access and play the associated media item. The standard URI is an example of an open-access identifier (or tag, etc.). The identifier is “open-access” in the sense that it enables the DMP (or other application, device, etc.) to access and/or play the content (e.g., media item) associated with the identifier without engaging in any type of access-control process or sequence.

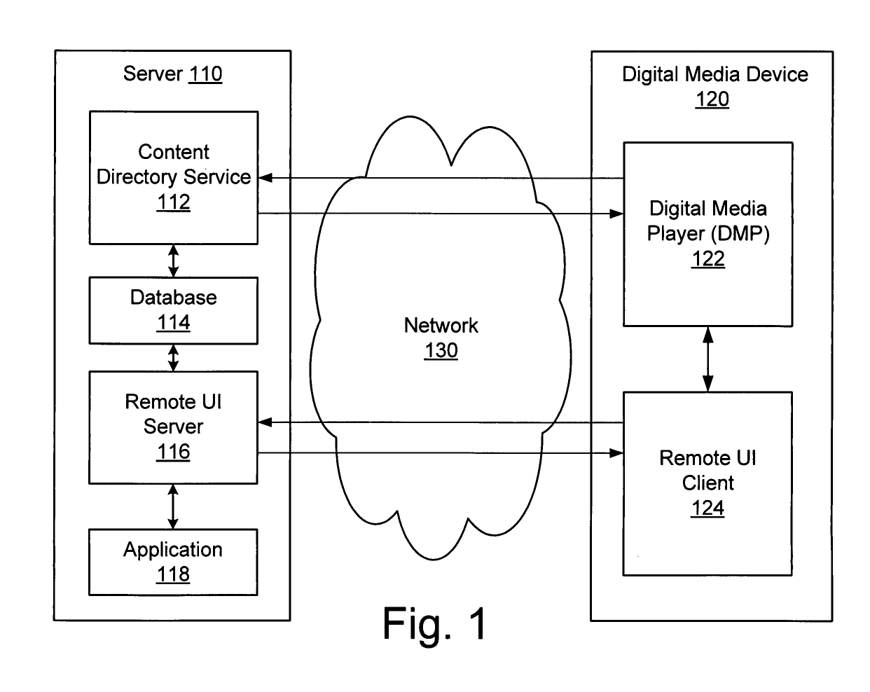

FIG. 1 illustrates an embodiment of a system that provides access control over media content (e.g., audio, video, images, etc.) on a network. Server 110 includes Content Directory Service (CDS) 112. The CDS exposes Universal Resource Identifiers (URIs) for each exposed media item in database 114 to clients on network 130. Other identifiers (e.g., eXtensible Markup Language (XML) tags, etc.) can be used in other embodiments. Additionally, the identifiers can identify information other than media items (e.g., files, documents, data, etc.). In the embodiment of FIG. 1, “standard” URIs (i.e., URIs having no access-protection) in CDS 112 point to media items in database 114. Meanwhile, URIs designated for access-protection point to RUI access control application 118 and are referred to as RUI URIs.

Digital Media Device 120 includes a UPnP Digital Media Player (DMP) 122 that browses network 130 for exposed URIs. CDS 112 provides a list of one or more URIs to DMP 122. When DMP 122 encounters a standard URI on the list, the URI is used to access and play (e.g., stream) the associated media item(s). When DMP 122 encounters a RUI URI, the media item cannot be directly accessed and played; instead, the RUI URI is passed to RUI client 124.

RUI client 124 establishes a connection with RUI server 116 via network 130 and requests access control application 118 as specified by the RUI URI. RUI server 116 remotes a user interface for access control application 118 to RUI client 124 for display on digital media device 120. The access control UI enables a user to enter a PIN, access code, password or other security information, which is then transmitted back to RUI server 116 for processing by access control application 118.

Once access control application 118 verifies the user-entered PIN, RUI server 116 retrieves a standard URI for the requested media item from database 114. In one embodiment, the user-entered PIN is valid on a per item basis only. In other embodiments, the user-entered PIN may be valid during a specified time period or for an entire session. RUI server 116 sends the URI for the media item to RUI client 124; RUI client 124 communicates the URI for the media item to DMP 122 where the media item can be accessed and played.

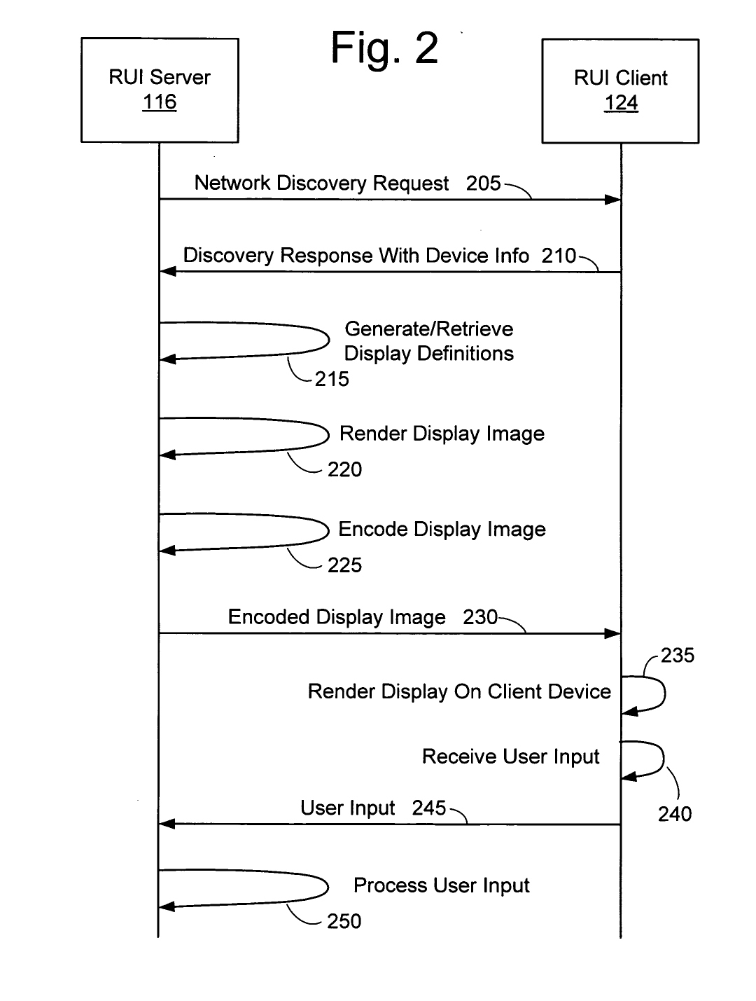

FIG. 2 illustrates in more detail the application level communications between RUI server 116 and RUI client 124 of FIG. 1. RUI server 116 initiates a network discovery request 205. RUI client 124 returns a discovery response 210 to RUI server 116 with device information about digital media device 120 (of FIG. 1). The device information includes decoding and display capabilities of the digital media device 120.

RUI server 116 then generates and/or retrieves 215 a display definition or definitions that may or may not be specific to digital media device 120.

Next, a display image (e.g., a graphical user interface (GUI)) is rendered 220 (e.g., by access control application 118) at the RUI server 116. RUI server 116 then encodes 225 the display image into a format for communicating and/or viewing on digital media device 120 (via RUI client 124). The encoded image is communicated 230 to RUI client 124. RUI client 124 then decodes and depicts the encoded image 235 for display on digital media device 120.

RUI client 124 receives user input 240 (e.g., PIN, access code, etc.) and communicates the user input 245 back to the RUI server 116. In alternate embodiments, the display image may be designed to allow RUI client 124 to also provide commands to other server/rendering devices in parallel or without providing commands to RUI server 116 (e.g., commands with no effect on the display image).

In various embodiments, different transmission protocols for “remoting” the display image and receiving user inputs may be employed. For example, a remote desktop protocol (“RDP”) available from Microsoft Corporation of Redmond, Wash. may be employed in one embodiment for remoting a display image and receiving user input. In another embodiment, the Extended Device Remoting Transfer Protocol, version 2 (“XRT2”), available from Intel Corporation of Santa Clara, Calif., can be used as a simple Transmission Control Protocol (TCP)-based command encapsulation protocol for passing messages back and forth between RUI server 116 and RUI client 124. XRT2 is a protocol that is suited to send display drawings and receive user input (such as keystroke commands from a keyboard and/or mouse movements and clicks).

Still referring to FIG. 2, once RUI server 116 receives user input the user input is processed 250.

In various embodiments, the communications described above and shown in FIG. 2 are merely one exemplary set of communications between RUI server 116 and RUI client 124. Other communications, both more and fewer, may be employed in other embodiments.

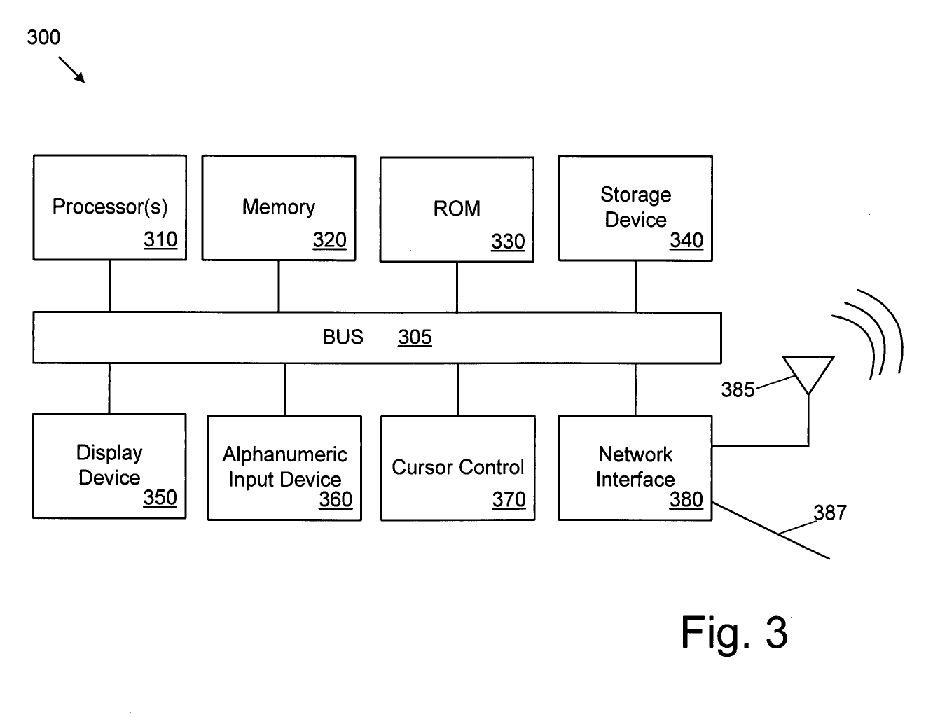

FIG. 3 is a block diagram of one embodiment of an electronic system. The electronic system illustrated in FIG. 3 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

Electronic system 300 includes bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as main memory), coupled to bus 305 and may store information and instructions that may be executed by processor 310. Main memory 320 may also be used to store temporary variables or other intermediate information during execution of instructions by processor 310.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a cathode ray tube (CRT) or liquid crystal display (LCD), to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display 350.

Electronic system 300 further may include network interface(s) 380 to provide access to a network, such as a local area network. Network interface(s) 380 may include, for example, a wireless network interface having antenna 385, which may represent one or more antenna(e). Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a local area network by conforming to IEEE 802.16 standards. IEEE 802.16 corresponds to IEEE 802.15-2005 entitled “Air Interface for Fixed Broadband Wireless Access Systems” approved Dec. 7, 2005 as well as related documents.

In one embodiment, network interface(s) 380 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 380 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Embodiments of the technology described above may include hardware, software, and/or a combination of these. In a case where an embodiment includes software, the software data, instructions, and/or configuration may be provided via an article of manufacture by a machine/electronic device/hardware. An article of manufacture may include a machine or computer accessible/readable medium having content to provide instructions, data, etc. The content may result in an electronic device performing various operations or executions described. A machine accessible medium includes any mechanism that provides (i.e., stores and/or transmits) information/content in a form accessible by a machine (e.g., computing device, electronic device, electronic system/subsystem, etc.). For example, a machine or computer accessible medium includes recordable/non-recordable media such as read only memory (ROM), random access memory (RAM), magnetic disk storage media, optical storage media, flash memory devices, etc. The machine accessible medium may further include an electronic device having code loaded on a storage that may be executed when the electronic device is in operation. Thus, delivering an electronic device with such code may be understood as providing the article of manufacture with such content described above.

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for a client device to retrieve access-protected resources from a server over a network, comprising:
receiving one or more identifiers for one or more resources from the server via an open-access protocol, wherein at least one identifier identifies a resource that is access-protected;
communicating a received identifier for an access-protected resource to a remote user interface (RUI) client;
requesting the access-protected resource from a RUI server;
transmitting an access code to the RUI server; and
receiving the access-protected resource in response to transmitting the access code.

2. The method of claim 1, wherein the client device is a digital media device.

3. The method of claim 1, wherein the open-access protocol is a Universal Plug and Play (UPnP) protocol.

4. The method of claim 1, wherein the at least one access-protected resource comprises a media file selected from the group consisting of an audio file, a video file, an image file, a video game file, and a slide show file.

5. The method of claim 1, wherein the access code is entered by a user of the digital media device.

6. The method of claim 5, wherein transmitting the user-entered access code to the RUI server causes the RUI server to initiate a session during which a plurality of access-protected resources may be retrieved without further access code entry by the user.

7. A system, comprising:
a memory unit to store media content;
an identification (ID) unit coupled with the memory unit, the ID unit having ID tags that identify the media content;
a transmission unit coupled with the memory unit and the ID unit to transmit a tag that identifies access-protected media content over a network via an open-access protocol;
a digital media player to receive the tag over the network;
a remote user interface (UI) client communicatively coupled to the digital media player to send a request over the network for the access-protected media content in response to the digital media player receiving the tag; and
a remote UI server coupled with the memory unit to
render a keycode entry UI image in response to receiving the request over the network;
send the keycode entry UI image to the remote UI client;
retrieve an open-access tag for the requested media content from the memory unit if a keycode is received from the remote UI client and the keycode matches a keycode stored in the remote UI server, and
send the open-access tag over the network to the remote client, the remote client subsequently to communicate the open-access tag to the digital media player.

8. The system of claim 7, wherein the network is an Internet Protocol (IP) network.

9. The system of claim 7, wherein the open-access protocol is a Universal Plug and Play (UPnP) protocol.

10. A digital media device, comprising:
a digital media player to receive an access-control identifier sent from a serving system over a network via an open-access protocol, the access-control identifier identifying media content that is access-controlled; and
a remoting client communicatively coupled with the digital media player to send, based at least in part on the access-control identifier, a request for the access-controlled media content to a remoting server of the serving system, the remoting server adapted to authenticate the request, and the remoting client further to communicate an open-access identifier for the requested media content to the digital media player in response to receiving the open-access identifier from the serving system.

11. The digital media device of claim 10, wherein the serving device sends the open-access identifier over the network using Universal Plug and Play (UPnP).

12. The digital media device of claim 10, wherein the request is authenticated by the serving device based at least in part on a successful entry of an access code by a user of the digital media device.

13. An article of manufacture comprising a computer-readable medium having content stored thereon to provide instructions to result in an electronic device performing operations including:
receiving one or more identifiers for one or more resources from the server via an open-access protocol, wherein at least one identifier identifies a resource that is access-protected;
communicating a received identifier for an access-protected resource to a remote user interface (RUI) client;
requesting the access-protected resource from a RUI server;
transmitting an access code to the RUI server; and
receiving the access-protected resource in response to transmitting the access code.

14. The article of manufacture of claim 13, wherein the open-access protocol is a Universal Plug and Play (UPnP) protocol.

15. The article of manufacture of claim 13, wherein the at least one access-protected resource comprises a media file selected from the group consisting of an audio file, a video file, an image file, a video game file, and a slide show file.

16. The method of claim 14, wherein the access code is entered by a user of the digital media device.

17. The method of claim 16, wherein transmitting the user-entered access code to the RUI server causes the RUI server to initiate a session during which a plurality of access-protected resources may be retrieved without further access code entry by a user.
